(19) United States
(12) Patent Application Publication
(10) Pub. No.: US 2007/0019916 A1
(43) Pub. Date: Jan. 25, 2007

(54) STEREOSCOPIC ILLUMINATION ENDOSCOPE SYSTEM

(75) Inventor: Satoshi TAKAMI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/458,232

(22) Filed: Jul. 18, 2006

(30) Foreign Application Priority Data
Jul. 20, 2005 (JP) 2005-209955

(51) Int. Cl. G02B 6/06

(52) U.S. Cl. 385/117

(57) ABSTRACT

A stereoscopic illumination endoscope system includes an endoscope processor; an electronic scope detachably attached to the endoscope processor, the electronic scope having a light guide provided therein, wherein the light guide includes a plurality of optical fiber bundles having incident-end faces arranged adjacent to each other and emission-end faces being arranged away from each other in a lateral direction thereof at the distal end; and an incident light controller which adjusts a quantity and quantity ratio of the illumination light emitted from the light source and incident on the respective incident-end faces, the incident light controller provided between the light source and the incident-end faces.

### BACKGROUND OF THE INVENTION

1. Field of the Invention

The present invention relates to a stereoscopic illumination endoscope system for facilitating stereoscopic observation of an object to be observed.

2. Description of the Related Art

Conventionally, endoscopes and endoscope systems have been provided with illumination units that are designed and adjusted so that illumination light emitted from the end of a body insertion part of the electronic scope thereof is uniformly incident on an object in an observed region, i.e., affected areas are illuminated so as to attain a planar view. Such uniform illumination units are less likely to cast shadows even if the affected areas have delicate asperities. This makes asperities hard to discover, and the extent of such asperities difficult to diagnose. One of the countermeasures proposed heretofore is a method disclosed in Japanese Patent Laid-Open Publication No. 2000-199864, in which a light guide is shifted in parallel in a direction orthogonal to the optical axis. An alternative method is disclosed in Japanese Patent Laid-Open Publication No. S64-70720, in which a light guide is made of optical fibers bundled in an innovative manner.

However, according to the method described in Japanese Patent Laid-Open Publication No. 2000-199864, the parallel shift of the light guide makes the light source unit and peripheral devices thereof larger. Furthermore, the method described in Japanese Patent Laid-Open Publication No. S64-70720 involves an impractically complicated manner of bundling the optical fibers.

### SUMMARY OF THE INVENTION

The present invention provides a stereoscopic illumination endoscope system which creates a contrast, shadow, or the like of an object to be observed to facilitate a stereoscopic view while maintaining ease of detachment/attachment between the scope and the processor without increasing the size of the light source unit.

According to an aspect of the present invention, a stereoscopic illumination endoscope system is provided, including an endoscope processor including a light source; an electronic scope detachably attached to the endoscope processor, the electronic scope having a light guide provided therein, wherein illumination light emitted from the light source is projected onto an object to be observed from a distal end of the electronic scope via the light guide, and wherein the light guide includes a plurality of optical fiber bundles having respective incident-end faces for the illumination light to be incident on and respective emission-end faces for the incident illumination light to be emitted from, the incident-end faces being arranged adjacent to each other, and the emission-end faces being arranged away from each other in a lateral direction thereof; and an incident light controller which adjusts a quantity and quantity ratio of the illumination light emitted from the light source and incident on the respective incident-end faces, the incident light controller provided between the light source and the incident-end faces. It is desirable for the light guide to include a pair of the optical fiber bundles; and for the incident-end faces of the pair of optical fiber bundles to be formed as substantially semicircular shapes so as to form a substantially circular shape as a whole.

It is desirable for the substantially semicircular incident-end faces to be arranged in a vertical direction when the electronic scope is detachably attached to the endoscope processor.

It is desirable for an image pickup device to be provided between the emission-end faces of the pair of optical fiber bundles at the distal end of the body insertion part of the electronic scope.

It is desirable for the incident light controller to include a light quantity control plate which is supported so as to be movable in the vertical direction, the control plate being formed so as to have a light transmittance which varies gradually or stepwise along the vertical direction.

It is desirable for the illumination light emitted from the light source to be a parallel light bundle, and for the light quantity control plate to have a lower transmittance in an area where an upper part of the illumination light passes.

It is desirable for the incident light controller to include a shield plate provided in an optical path between the light source and the incident-end faces of the pair of optical fiber bundles, the shield plate having upper and lower apertures, wherein the shield plate is moved up and down to adjust respective light quantities of the illumination light which pass through the upper and lower apertures of the shield plate.

It is desirable for the incident light controller to include a shield plate provided in an optical path between the light source and the incident-end faces of the pair of optical fiber bundles, the shield plate dividing the illumination light into a plurality of light bundles to be incident on the incident-end faces, respectively, and the shield plate being moved up and down to adjust respective sizes of the upper and lower apertures.

It is desirable for the light guide to include a pair of the optical fiber bundles. The incident-end faces of the pair of optical fiber bundles are formed as split halves of a polygon so as to form the polygon as a whole when arranged in close contact with each other.

It is desirable for the split halves of the polygon incident-end faces to be arranged in a vertical direction when the electronic scope is detachably attached to the endoscope processor.

It is desirable for an image pickup device to be provided between the emission-end faces of the pair of optical fiber bundles at the distal end of the body insertion part of the electronic scope.

It is desirable for the incident light controller to include a light quantity control plate which is supported so as to be movable in the vertical direction, the control plate being formed so as to have a light transmittance which varies one of gradually and stepwise along the vertical direction.

It is desirable for the illumination light emitted from the light source includes a parallel light bundle; and for the light quantity control plate to have a lower transmittance in an area where an upper part of the illumination light passes.

It is desirable for the incident light controller to include a shield plate provided in an optical path between the light source and the incident-end faces of the pair of optical fiber bundles, the shield plate having upper and lower apertures.

It is desirable for the light shield to include a shield plate provided in an optical path between the light source and the incident-end faces of the pair of optical fiber bundles, the shield plate being moved up and down to adjust respective light quantities of the illumination light which pass through the upper and lower apertures of the shield plate.

It is desirable for the light source to include a lamp for emitting a parallel light bundle, and a condenser lens for focusing the parallel light bundle emitted from the lamp. The light quantity control plate is provided between the lamp and the condenser lens.

It is desirable for the light source to include a lamp for emitting a parallel light bundler and a condenser lens for focusing the parallel light bundle emitted from the lamp. The shield plate is provided between the condenser lens and the incident-end faces of the optical fiber bundles.

In an embodiment, an electronic scope is provided detachably attached to the endoscope processor including a light guide provided therein, wherein illumination light emitted from a light source is projected onto an object to be observed from a distal end of the electronic scope via the light guide. The light guide includes a plurality of optical fiber bundles having respective incident-end faces for the illumination light to be incident on and respective emission-end faces for the incident illumination light to be emitted from, the incident-end faces being arranged adjacent to each other, and the emission-end faces being arranged away from each other.

In an embodiment, an endoscope processor is provided detachably attached to an electronic scope including a light source which emits illumination light so as to be incident on an incident end face of a light guide provided in the electronic scope and to emit from a distal end of the light guide. The light guide includes a plurality of optical fiber bundles having respective incident-end faces for the illumination light to be incident on and respective emission-end faces for the incident illumination light to be emitted from, the incident-end faces being arranged adjacent to each other, and the emission-end faces being arranged away from each other in a lateral direction thereof. An incident light controller is provided between the light source and the incident-end faces, wherein the incident light controller adjusts a quantity and quantity ratio of the illumination light emitted from the light source and incident on the respective incident-end faces.

The present disclosure relates to subject matter contained in Japanese Patent Application No. 2005-209955 (filed on Jul. 20, 2005) which is expressly incorporated herein in its entirety.

### BRIEF DESCRIPTION OF THE DRAWINGS

The present invention will be discussed below in detail with reference to the accompanying drawings, in which:

FIG. 1 is a block diagram showing the essential configuration of a stereoscopic illumination endoscope system to which the present invention is applied;

FIG. 2 is a schematic view of an electronic scope according to the present invention;

FIG. 3 is a schematic view of a light guide built in the electronic scope;

FIGS. 4A and 4B are diagrams explaining the configuration of the first embodiment of the stereoscopic illumination endoscope system and illumination distributions which vary depending on the optical axis position, FIG. 4A showing the optical axis positional relationship between a lamp, a light quantity control plate, and the main shield plate, and FIG. 4B showing illumination distributions on planes orthogonal to the optical axis at respective positions in the direction of the optical axis;

FIG. 5 is a diagram showing the relationship between the lamp, the condenser lens, the light quantity control plate, the main shield plate, and the lamp beams on the incident-end faces of the light guides according to the first embodiment, for situations where the incident end faces are arranged farther than the focal position of the condenser lens;

FIGS. 6A and 6B are diagrams explaining the configuration of a second embodiment of the stereoscopic illumination endoscope system and illumination distributions which vary depending on the optical axis position, FIG. 6A showing the optical axis positional relationship between the lamp, the light quantity control plate, and the main shield plate, and FIG. 6B showing illumination distributions on planes orthogonal to the optical axis at respective positions in the direction of the optical axis;

FIG. 7 is a diagram showing the relationship between the lamp, the condenser lens, the light quantity control plate, the main shield plate, and the lamp beams on the incident-end faces of the light guides according to a second embodiment, for situations where the incident-end faces are arranged farther than the focal position of the condenser lens;

FIGS. 8A and 8B are diagrams explaining the configuration of third embodiment of the stereoscopic illumination endoscope system and illumination distributions which vary depending on the optical axis position, FIG. 8A showing the optical axis positional relationship between the lamp, the light quantity control plate, and the main shield plate, and FIG. 8B showing illumination distributions on planes orthogonal to the optical axis at respective positions in the direction of the optical axis;

FIG. 9 is a diagram showing the relationship between the lamp, the condenser lens, the light quantity control plate, the main shield plate, and the lamp beams on the incident-end faces of the light guides according to a third embodiment, for situations where the incident-end faces are arranged farther than the focal position of the condenser lens;

FIG. 10 is a diagram for explaining the configuration of a fourth embodiment in which the main shield plate of the stereoscopic illumination endoscope system is moved, and the relationship between the position of the main shield plate and the amounts of light incident on the respective light guides thereof;

FIG. 11 is a diagram for explaining the relationship between the position of the main shield plate and the amounts of light incident on the respective light guides according to the fourth embodiment in which the main shield plate is moved;

FIG. 12 is a perspective view showing essential parts of the fourth embodiment;

FIG. 13 is a diagram showing the relationship between an affected area and its shadow when illuminated by the stereoscopic illumination endoscope system according to the fourth embodiment;

FIG. 14 is a schematic view of a practical example of the mechanism for moving the light quantity control plate up and down according to the present invention;

FIG. 15 is a schematic view of a practical example of the mechanism for moving the light quantity control plate up and down in the embodiments shown in FIGS. 6A through 9; and

FIG. 16 is a schematic view of a practical example of the mechanism for moving the light quantity control plate up and down in the fourth embodiment shown in FIGS. 10 through 13.

### DETAILED DESCRIPTION OF THE PREFERRED EMBODIMENTS

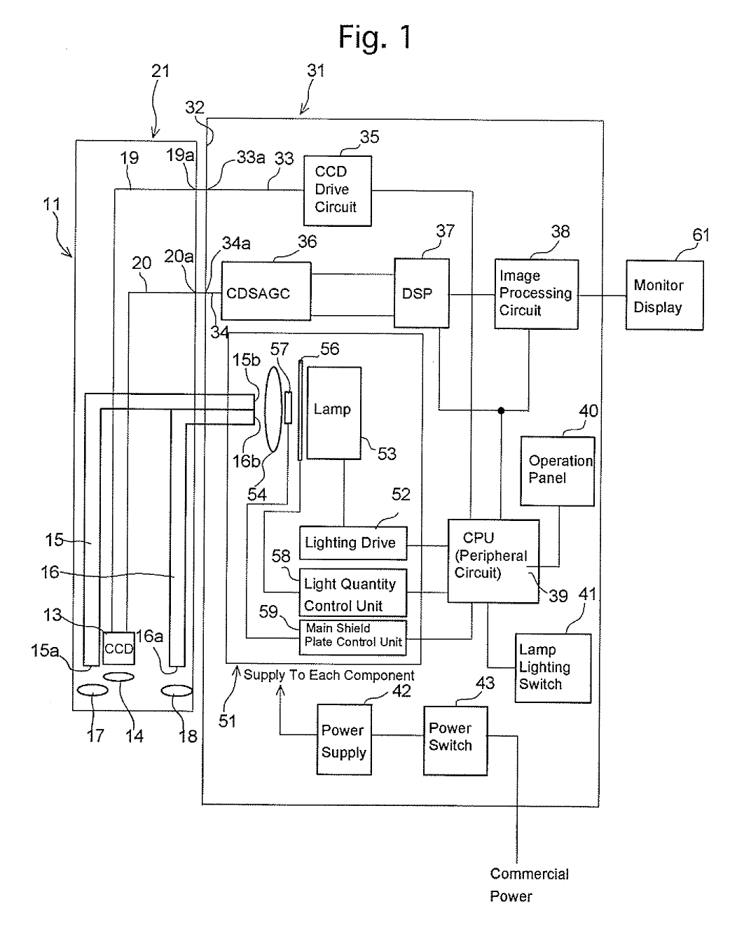

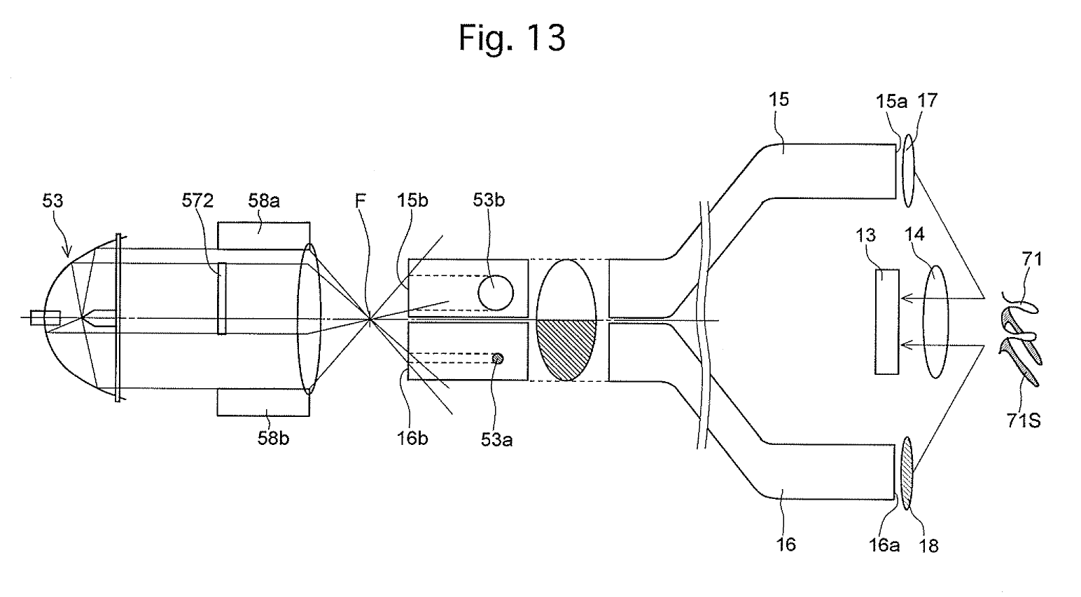

The present invention will be described in more detail with reference to FIGS. 1 through 16.

FIG. 1 is a block diagram of an electronic endoscope system to which the present invention is applied. This electronic endoscope system includes an electronic scope 11, a processor 31 to which the electronic scope 11 is detachably connected, and a monitor display 61 which is connected to the processor 31. The electronic scope 11 captures an image via an image pickup device, and the processor 31 processes a signal of the captured image. The resulting image is displayed on the monitor display 61 which is connected with the processor 31, and is stored in a storage medium which is either built-in or connected with the processor 31, and/or printed out by a printer (not shown) which is connected with the processor 31.

The electronic scope 11 has a body insertion part 12, an operation part, and a connector part 21. The body insertion part 12 is for insertion into a body cavity of a patient. The electronic scope 11 is detachably connected to the processor 31 through the connector part 21.

The image pickup device including a CCD image sensor 13 and an objective lens (photographing lens) 14 is arranged in the end of the body insertion part 12. The objective lens 14 forms an image of an affected area on the CCD image sensor 13. The body insertion part 12 also includes a light guide which is composed of a pair of optical fiber bundles 15 and 16, each having a large number of optical fibers. Emission-end faces 15a and 16a of the pair of optical fiber bundles 15 and 16 are located at positions corresponding to the right and left (or top and bottom sides) with the CCD image sensor 13 therebetween. Light distribution lenses 17 and 18 are provided in front of the emission-end faces 15a and 16a of the optical fiber bundles 15 and 16, respectively, with the objective lens 14 provided therebetween. The light distribution lenses 17 and 18 diffuse illumination light emitted from the emission-end faces 15a and 16a at a predetermined distribution. It should be noted that the objective lens 14 and the light distribution lenses 17 and 18 are mounted so that a photographic aperture and a pair of illumination apertures formed in the distal end of the external cylinder of the body insertion part 12 are sealed tightly. Moreover, the distal end of the body insertion part 12 is typically provided with a forceps hole or the like intended for forceps access, etc.

The other ends (proximal ends) of the optical fiber bundles 15 and 16 are formed as incident-end faces 15b and 16b, each having a semicircular shape. The incident-end faces 15b and 16b are adjacent to each other and are fixed inside the connector part 21 of the electronic scope 11 so as to form a circular shape as a whole. When the connector part 21 is connected with a connector of the processor 31, the incident-end faces 15b and 16b are each located slightly farther away from the condenser lens 54 of the light source unit 51 than the focal point of the condenser lens 54. The light source unit 51 has a light quantity control plate (light quantity controller) 56 and a main shield plate (light shield) 57 which are provided between the light source lamp 53 and the condenser lens 54. Although it is desirable for the incident-end faces 15b and 16b of the optical fiber bundles 15 and 16 to have semicircular shapes in terms of manufacturing efficiency, the incident-end faces 15b and 16b may be shaped as split halves of a polygon (incident-end faces 15b′ and 16b′, FIG. 3) so as to form a polygon as a whole when arranged in close contact with each other in a vertical direction with respect to the direction of incidence of the illumination light. In this case, it is desirable for the incident-end faces 15b and 16b to be configured to form a generally square shape as a whole.

The light quantity control plate 56 and the main shield plate 57 constitute an The light quantity control plate 56 and the main shield plate 57 constitute an incident light controller, having a light quantity adjustment function and a light quantity ratio adjustment function. The light quantity adjustment function is for adjusting the size of a parallel light bundle that is emitted from the light source lamp 53 and incident on the incident-end faces 15b and 16b. The light quantity ratio adjustment function is for providing differing amounts of light incident on the respective incident-end faces 15b and 16b. The light quantity control plate 56 and the main shield plate 57 are driven and controlled by a CPU 39 via a light quantity control unit 58 and a main shield plate control unit 59.

In the above-described arrangement, the light emitted from the light source lamp 53 is focused by the condenser lens 54 to be incident on the incident-end faces 15b and 16b as illumination light. The illumination light is guided through the optical fiber bundles 15 and 16, emitted from the emission-end faces 15a and 16a, and diffused by the light distribution lenses 17 and 18 at a predetermined light distribution. The diffused light thereafter illuminates an object to be observed, such as the interior of a patient's body cavity.

The CCD image sensor 13 is connected with a drive signal line 19 and a picture signal line 20. The drive signal line 19 and the picture signal line 20 are laid through the body insertion part 12, and connected to a drive signal pin 19a and a picture signal pin 20a, respectively, inside the connector part 21. The drive signal pin 19a and the picture signal pin 20a are connected to a corresponding drive signal pin 33a and a corresponding picture signal pin 34a in a connector receptacle 32 of the processor 31. The drive signal pin 33a and the picture signal pin 34a are connected to a drive signal line 33 and a picture signal line 34, respectively. The drive signal line 33 is connected to a CCD drive circuit 35, and the image signal line 34 is connected to an initial-stage processing circuit (correlated double sampling and auto gain controller (CDSAGC)) 36. The CCD image sensor 13 captures an image based on a CCD drive signal which is output from the CCD drive circuit 35 and input through the drive signal lines 33 and 19.

The CCD image sensor 13 captures an image inside the body cavity illuminated with the illumination light that is emitted from the optical fiber bundles 15 and 16 at the predetermined light distribution via the light distribution lenses 17 and 18. The CCD image sensor 13 outputs the resulting picture signal through the picture signal line 20 and the connector part 21. The initial-stage processing circuit 36 inputs the picture signal from the connector part 21 through the picture signal line 34, applies a predetermined analog process such as correlated double sampling and auto gain control thereto, and then converts the analog signal into a digital signal. A digital signal processor (DSP) 37 applies a predetermined digital process such as gamma correction to the digital signal. An image processing circuit 38 further converts the digital signal into an analog video signal, or the like, of a predetermined format, which is displayed on the monitor display 61 as a moving image or a still image. The image processing circuit 38 also converts the digital signal into a digital image signal of a predetermined format, which is recorded on a recording medium in accordance with a user command (operation), etc.

The processor 31 includes the CPU 39 which controls the entire endoscope system. The CPU 39 operates under switch operations on the operation panel 40, which is mounted on the exterior of the processor 31 and has various types of switches. The processor 31 also has a lamp lighting switch 41 for turning ON/OFF the illumination (light source lamp 53). When the lamp lighting switch 41 is turned ON, the CPU 39 activates a lighting drive unit 52 to turn on the light source lamp 53.

The processor 31 has a power supply 42 for supplying electric power to devices and electronic components necessary for the operation of the endoscope system, including the light source unit 51, the CPU 39, control system circuits, and other electronic components. The power supply 42 has the function of transforming and rectifying alternating-current power obtained from a commercial power supply. The power supply 42 supplies the resultant to the electronic components such as the light source unit 51 and the CPU 39 when a power switch 43 is turned ON.

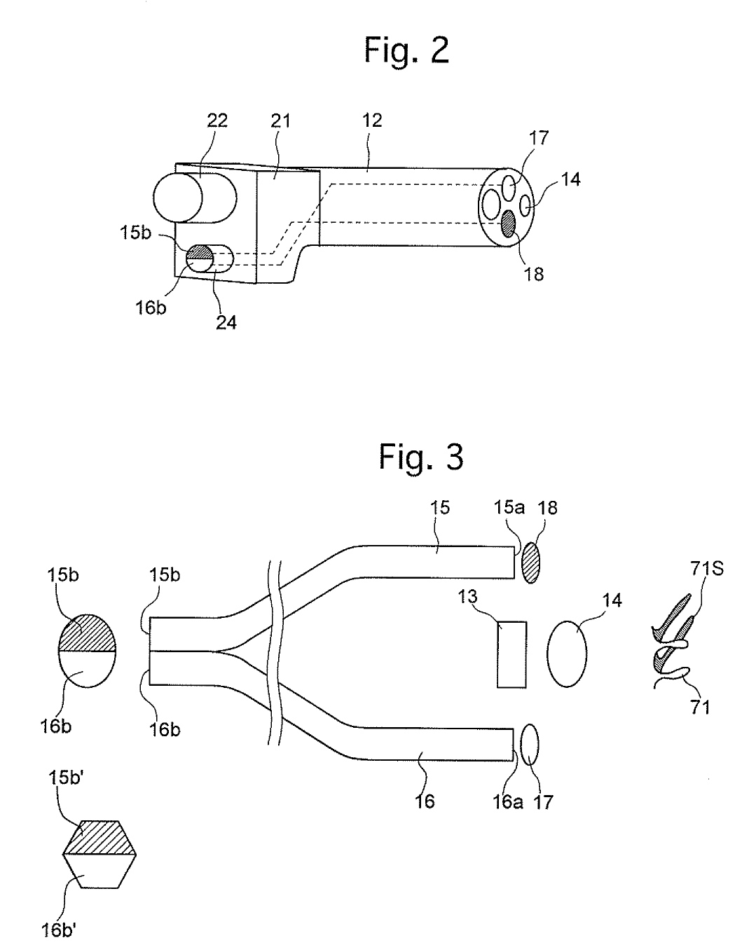

FIG. 2 shows an embodiment of the overall structure of the optical fiber bundles 15 and 16. In the illustrated embodiment, the incident-end faces 15b and 16b of the respective optical fiber bundles 15 and 16 are semicircular in shape. The incident-end faces 15b and 16b are inserted and fixed into a light guide casing cylinder 24 and are arranged in a vertical direction with respect to the direction of incidence of the illumination light (perpendicularly in the direction of gravity) so as to form a circular shape as a whole. The incident-end faces 15b and 16b are positioned away from the focal point of the condenser lens 54 so that the spot diameter of the light bundle emitted from the light source 53 falls within the incident-end faces 15b and 16b. The illumination light incident on the incident-end faces 15b and 16b is guided through the optical fiber bundles 15 and 16, emitted from the emission-end faces 15a and 16a, and diffused and projected through the light distribution lenses 17 and 18.

In the prior art, the light bundle from the light source is uniformly incident on the incident end, and uniformly projected from the light distribution lens to illuminate an affected area uniformly with no difference in illumination. On the other hand, the present invention provides a light quantity control device which provides differing illuminances and differing light quantities between the pair of illumination light bundles emitted from the pair of optical fiber bundles 15 and 16, thereby facilitating a stereoscopic view of the subject (object). FIGS. 2 and 3 show the state where the amount of light incident on the incident end 16b of the lower optical fiber bundle 16 is greater than that of light incident on the incident end 15b of the upper optical fiber bundle 15. Since the light emitted from the emission end 16a is greater in amount, an affected area 71 casts a shadow 71S on the side of the emission-end faces 15a (FIG. 3).

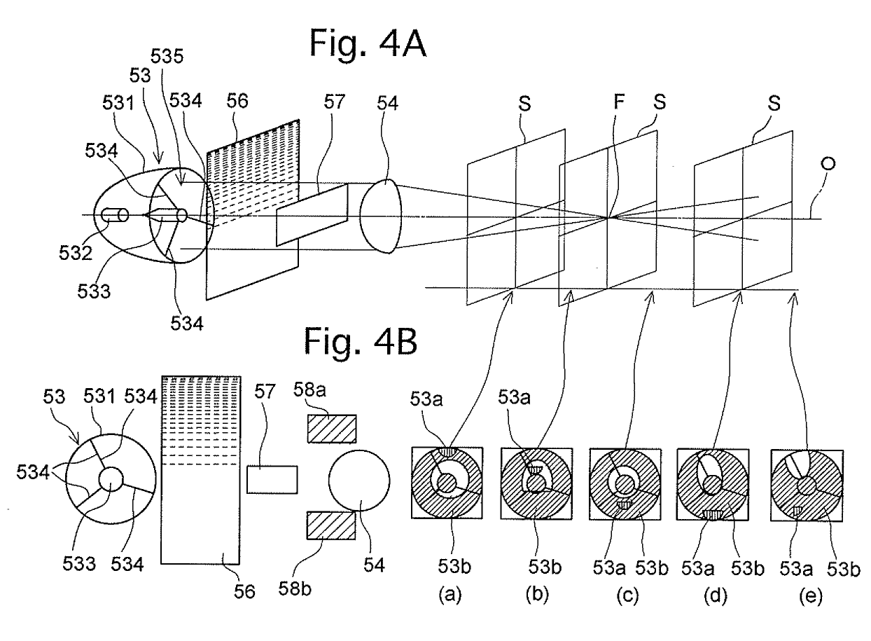

First through fourth embodiments of the stereoscopic illumination endoscope system, to which the present invention is applied, will be herein described with reference to FIGS. 4A through 16. In the first through fourth embodiments, the illumination light emitted from the light source unit 51 is guided through the pair of optical fiber bundles 15 and 16, and emitted from the pair of light distribution lenses 17 and 18 as a pair of illumination light bundles having differing characteristics such as illumination and light distribution.

### Embodiment 1

FIG. 4A shows the first embodiment of the present invention in which the light quantity control plate 56 is provided closer to the light source lamp 53, and the main shield plate 57 is provided closer to the incident-end faces 15b and 16b. The light quantity control plate 56 and main shield plate 57 provides differing quantities of light incident on the incident-end faces 15b and 16b, and also provides a light quantity control. In the first embodiment, a known xenon lamp having a built-in reflector is used as the light source lamp 53. The light source lamp 53 includes a reflector 531, an anode 532, and a cathode 533. The anode 532 protrudes inward from the apex of the reflector 531 along an optical axis O. The cathode 533 is arranged inside the reflector 531, with an end opposed to the end of the anode 532. The cathode 533 is supported by three metal plates 534 which extend toward the optical axis from the opening rim of the reflector 531. A heat-resistant transparent plate 535 is tightly fixed to the opening of the reflector 531, thereby enclosing xenon gas in the reflector 531. An arc discharge occurring between the anode 532 and the cathode 533 produces light, which is reflected by the reflector 531 and emitted through the transparent plate 535. Note that this light source lamp 53 is configured so that the beams of light produced by the arc discharge are reflected by the reflector 531 and transmitted through the transparent plate 535 as a substantially parallel light bundle.

The light quantity control plate 56 and the main shield plate 57 are provided, in that order from the light source lamp 53, between the light source lamp 53 and the condenser lens 54. The light quantity control plate 56 is a filter that is formed so that its light transmittance varies gradually or stepwise along the vertical direction from the top to the bottom. In this embodiment, the transmittance decreases toward the top and increases toward the bottom. The main shield plate 57 extends across the optical path, shielding the central portion of the parallel light bundle emitted from the light source lamp 53.

According to this configuration, the light bundle emitted from the light source lamp 53 is transmitted through the light quantity control plate 56 and converted into a light bundle having a gradually increasing brightens in a downward direction. The light bundle is blocked in the center by the main shield plate 57 and split into top and bottom light bundles when transmitted through the condenser lens 54. The beams are focused into respective focal points F by the condenser lens 54, and diverge upon passing through the focal points F.

As shown in FIG. 4B, a top shield plate 58a and a bottom shield plate 58b are arranged above and below the main shield plate 57 as light shielding members for preventing the light bundles emitted from the light source lamp 53 from leaking. Namely, the main shield plate 57, the top shield plate 58a and the bottom shield plate 58b constitute a light shield, so that the parallel light bundle emitted from the light source lamp 53 passes through an upper aperture which is defined by the main shield plate 57 and the top shield plate 58a, and a lower aperture which is defined by the main shield plate 57 and the bottom shield plate 58b. Although the top and bottom shield plates 58a and 58b are shown in FIG. 4B, these plates may be formed as part of a box or annular member.

Furthermore, FIG. 4B shows illumination distributions (projection images of the light source) created by the light quantity control plate 56 and the main shield plate 57. FIG. 4A is a perspective view showing a physical relationship between the light source lamp 53, the light quantity control plate 56, the main shield plate 57, the condenser lens 54, and projection images. FIG. 4B explains illumination distributions of the illumination light at different distances from the condenser lens 54, showing front views of the light source lamp 53, the light quantity control plate 56, the main shield plate 57, and the condenser lens 54, and illumination distributions at different distances. In FIG. 4A, the symbol S represents a screen perpendicular to the optical axis O. The illumination distributions of the illumination light projected on screens S are shown in FIG. 4B. In FIG. 4B, (a) and (b) show illumination distributions when the screen S is positioned on the near side of the focal point F of the condenser lens 54 (closer to the condenser lens 54), and (c), (d), and (e) show illumination distributions when the screen S is provided on the far side of the focal point F. In FIG. 4B, the reference numeral 53a represents an illumination distribution of the light bundle which passes through an aperture defined by the main shield plate 57 and the top shield plate 58a. The reference numeral 53b represents an illumination distribution of the light bundle which passes through an aperture defined by the main shield plate 57 and the bottom shield plate 58b. Note that these two apertures are almost identical in area.

The light bundle emitted from the upper part of the light source lamp 53 has some fluctuations (flickering) due to gas convection inside the reflector 531 of the light source lamp 53. However, in this embodiment, the light quantity control plate 56 is formed so as to decrease in transmittance at upper areas thereof where the fluctuating light bundle is transmitted. An adverse effect of fluctuations on the illumination distributions can be reduced.

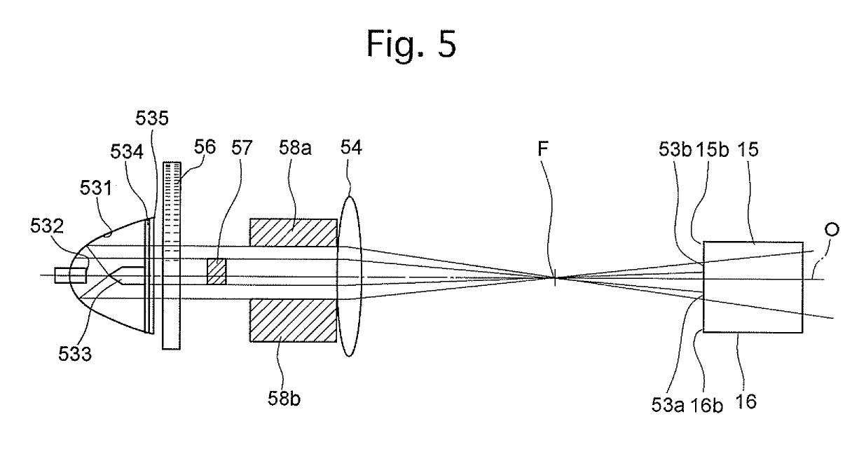

FIG. 5 is a longitudinal sectional view of the embodiment shown in FIGS. 4A and 4B, taken longitudinally along the optical axis. In this embodiment, the incident-end faces 15b and 16b of the optical fiber bundles 15 and 16 are located at position (d) on the far side of the focal point F in FIGS. 4A and 4B. Since the incident-end faces 15b and 16b are provided on the far side of the focal point F, with respect to the condenser lens 54, the upper light bundle is incident on the lower incident end 16b and the lower light bundle is incident on the upper incident end 15b. In other words, the amount of light incident on the upper incident end 15b is greater than the amount of light incident on the lower incident end 16b in this case. Consequently, the amount of light emitted from the emission end 15a is greater than that of light from the emission end 16a.

### Embodiment 2

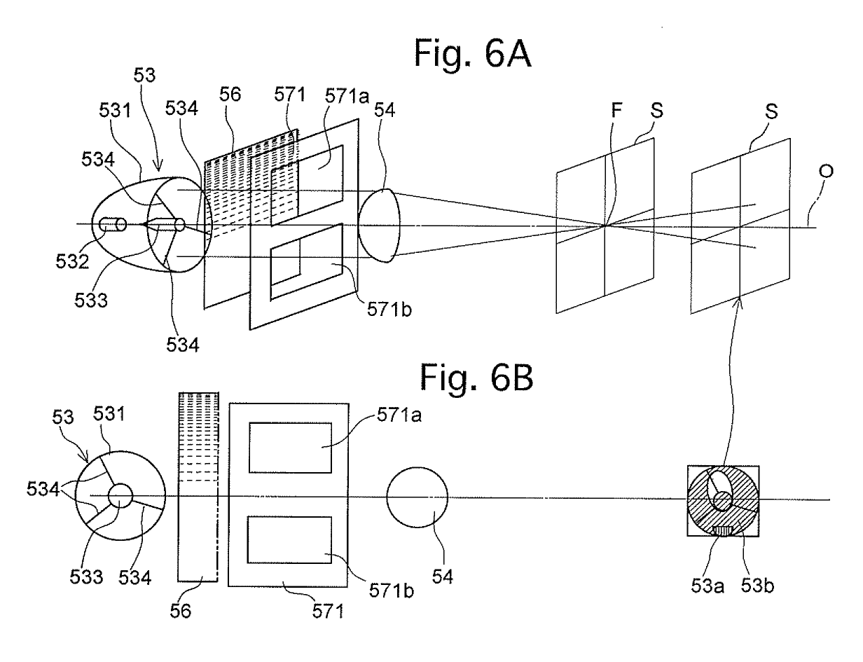

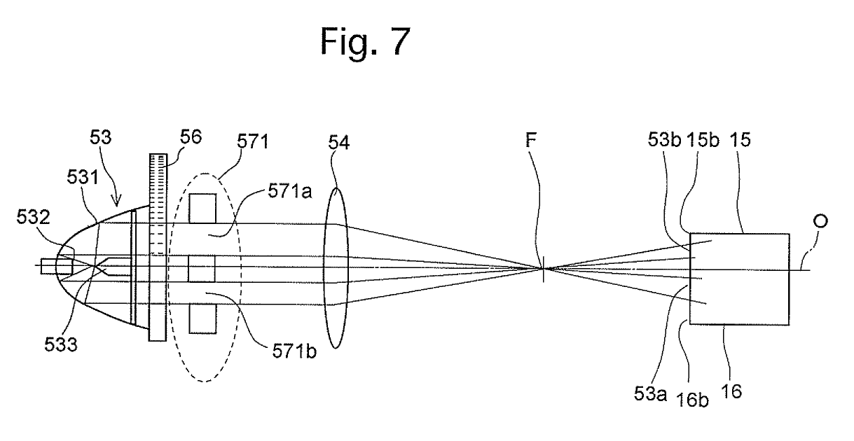

The second embodiment according to the present invention will be described with reference to FIGS. 6A through 7. The first embodiment shown in FIGS. 4A to 5 has dealt with the case where the top shield plate 58a and the bottom shield plate 58b are arranged with a main shield plate (light shield) 571 therebetween, defining an upper aperture and a lower aperture; whereas in the second embodiment, an upper aperture 571a and a lower aperture 571b are formed in a main shield plate 571 instead. In the second embodiment, the light quantity control plate 56 and the main shield plate 571 are arranged between the light source lamp 53 and the condenser lens 54. The upper aperture 571a and the lower aperture 571b of the main shield plate 571 are substantially identical in area. FIGS. 6B and 7 shows illumination distributions of the upper and lower light bundles 53a and 53b incident on the incident-end faces 15b and 16b with the incident-end faces 15b and 16b positioned on the far side of the focal point F.

### Embodiment 3

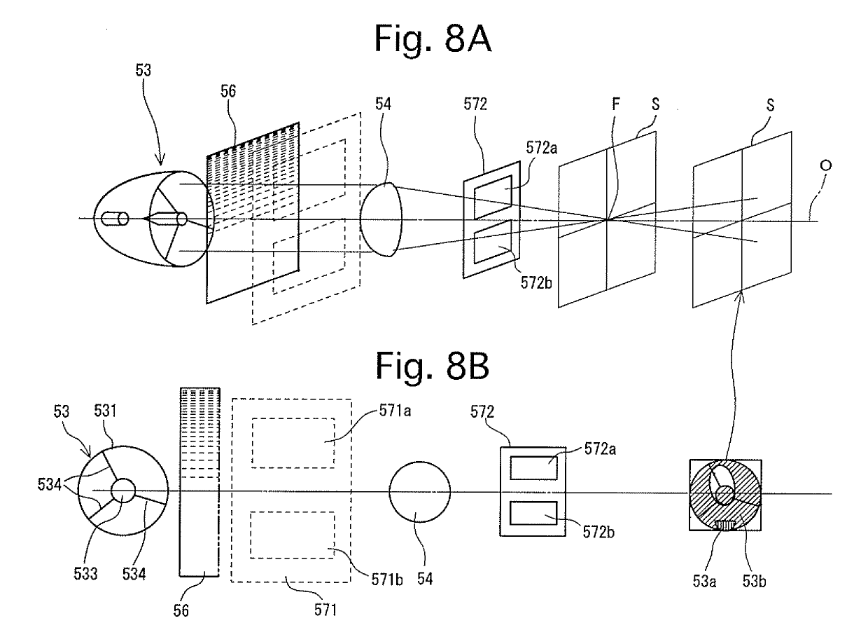

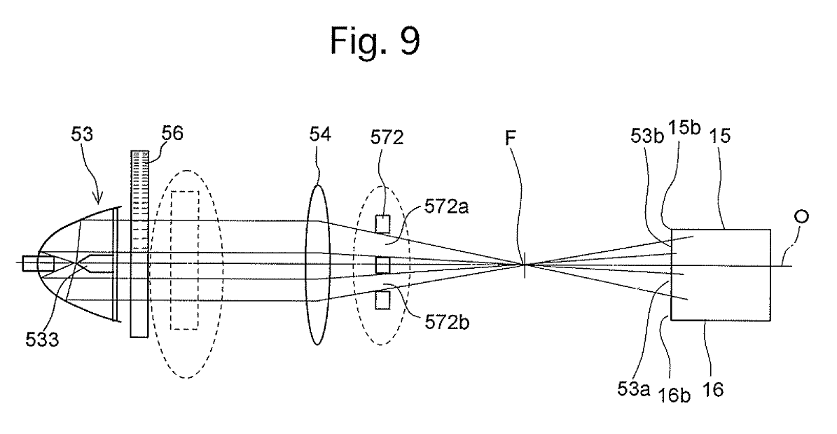

FIGS. 8A through 9 show the configuration of the third embodiment in which a main shield plate 572 is arranged between the condenser lens 54 and the incident-end faces 15b and 16b. In the third embodiment, since the main shield plate 572 is placed between the condenser lens 54 and the incident-end faces 15b and 16b, the light bundle passes through the main shield plate 572 with a smaller diameter due to the focusing of the condenser lens 54. Consequently, an upper aperture 572a and a lower aperture 572b of the main shield plate 572 can be formed smaller than the upper aperture 571a and the lower aperture 571b of the main shield plate 571 shown in FIGS. 6A through 7. This makes it possible to reduce the area of the main shield plate 572. In other respects, the configuration and function of the third embodiment are the same as the second embodiment.

### Embodiment 4

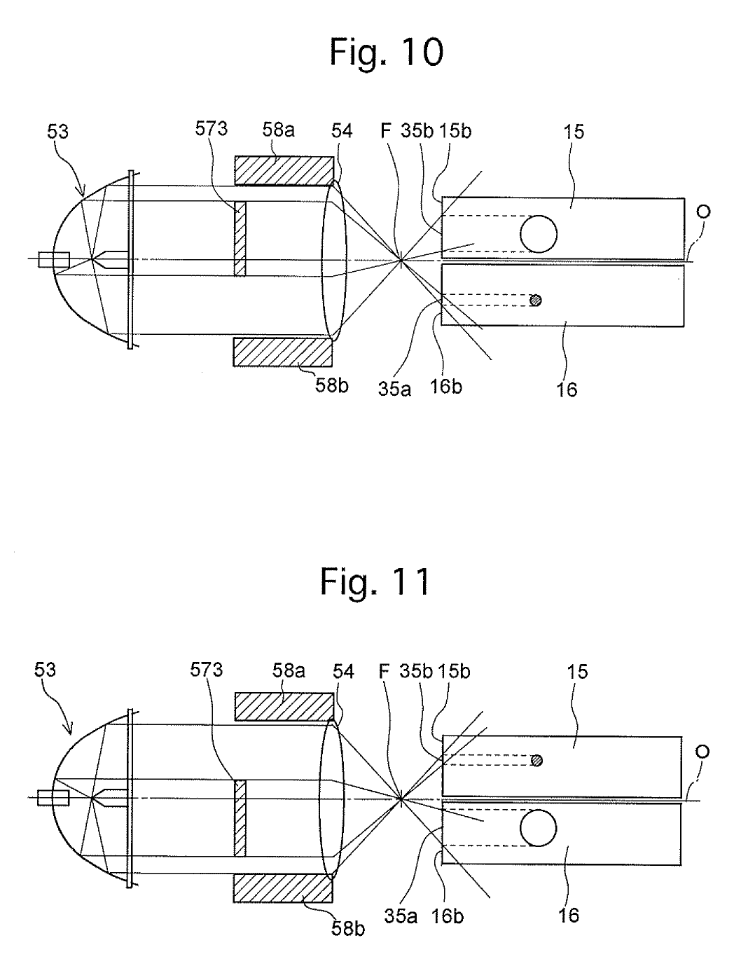

FIGS. 10 to 13 show embodiment 4 of the present invention. Embodiment 4 is characterized in that the light quantity control plate 56 is used to reduce the amount of light in the upper area, and a main shield plate 573 horizontally extending across the optical path is moved up and down to modify the ratio between the amounts of light incident on the incident-end faces 15b and 16b further.

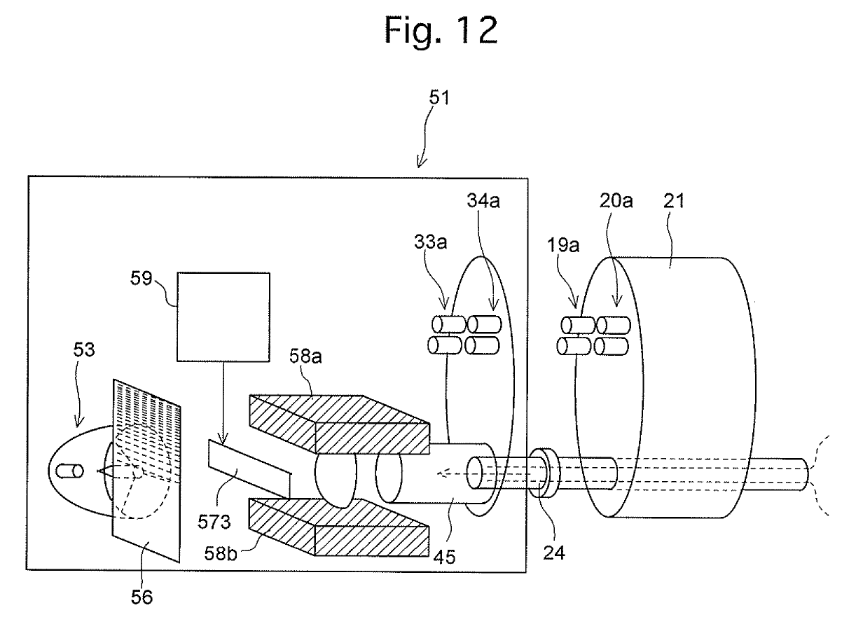

The main shield plate 573 lies in the optical path defined by the top and bottom shield plates 58a and 58b which extend in the horizontal direction (FIG. 12). The condenser lens 54 is arranged between the shield plates 58a and 58b, closer to the incident-end faces 15b and 16b.

In this embodiment, the main shield plate 573 moves up and down between the top shield plate 58a and the bottom shield plate 58b. An upward movement of the main shield plate 573 decreases the upper aperture and increases the lower aperture. As a result, the amount of light incident on the upper incident end 15b becomes greater than that of light incident on the lower incident end 16b (see FIG. 10). Conversely, a downward movement of the main shield plate 573 increases the upper aperture and decreases the lower aperture, so that the amount of light incident on the lower incident end 16b becomes greater than that of light incident on the upper incident end 15b (see FIG. 11).

In this embodiment, the main shield plate 573 can be moved up and down to adjust the ratio between the amounts of light incident on the incident-end faces 15b and 16b. In addition, the light quantity control plate 56 can be moved up and down to make an overall light quantity adjustment.

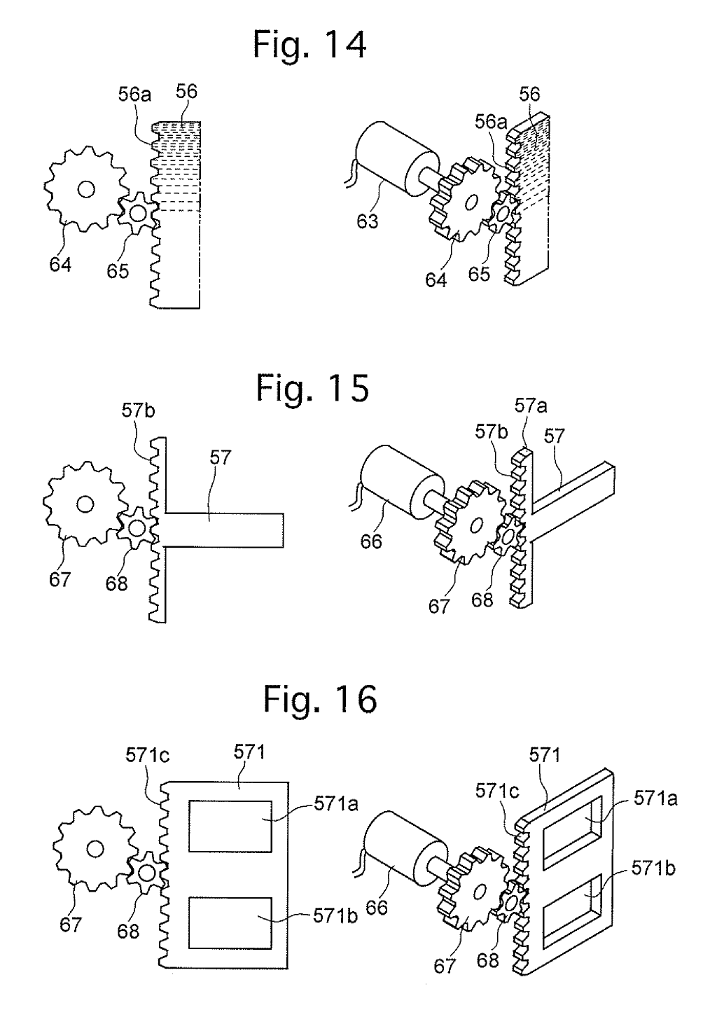

FIGS. 14, 15, and 16 show practical examples of the mechanisms for moving the light quantity control plate 56, the main shield plate 57, and the main shield plate 571 up and down.

As shown in FIG. 14, the light quantity control plate 56 has a vertically-extending rack 56a which is formed on one side thereof. The vertically-extending rack 56a meshes with a pinion 65. The pinion 65 meshes with a pinion 64 which is fixed to the rotating shaft of a motor 63. In other words, when the motor 63 rotates in a forward direction or a reverse direction, the light quantity control plate 56 moves up or down to change the light quantity incident on the respective incident-end faces 15b and 16b.

As shown in FIG. 15, the main shield plate 57 is provided with a vertically-extending rack plate 57a which is integrally formed on one end. A rack 57b formed on the vertically-extending rack plate 57a meshes with a pinion 68. This pinion 68 meshes with a pinion 67 which is fixed to the rotating shaft of a motor 66. Consequently, when the motor 66 rotates in a forward direction or a reverse direction, the main shield plate 57 is moved up or down via the pinions 67 and 68 and the rack 57b. Such movement of the main shield plate 57 changes the ratio between the light quantity incident on the incident-end faces 15b and 16b.

As shown in FIG. 16, the main shield plate 571 has a vertically-extending rack 571c which is formed on one of outer edges of its frame part. The vertically-extending rack 571c meshes with a pinion 68, which meshes with a pinion 67 fixed to the rotating shaft of a motor 66. Consequently, when the motor 66 rotates in a forward direction or a reverse direction, the main shield plate 56 is moved up or down via the pinions 67 and 68 and the rack 571c. This changes the ratio between the amounts of light incident on the incident-end faces 15b and 16b.

In these examples, the motor 63 is driven and controlled by the CPU 39 via the light quantity control unit 58, and the motor 66 is driven and controlled by the CPU 39 via the main shield plate control unit 59.

According to the present invention, the light quantity control plate can be moved in a simple manner in directions orthogonal to the optical axis of the light source so that an observed region is illuminated with different illuminances or distributions of illumination across the center of the capturing screen, creating a contrast or shadow of the stereoscopic subject (object), thereby providing a clear, stereoscopic view of 3-dimensional shapes or asperities.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. A stereoscopic illumination endoscope system comprising:
an endoscope processor including a light source;
an electronic scope detachably attached to said endoscope processor, said electronic scope having a light guide provided therein, wherein illumination light emitted from said light source is projected onto an object to be observed from a distal end of said electronic scope via said light guide, and wherein said light guide includes a plurality of optical fiber bundles having respective incident-end faces for the illumination light to be incident on and respective emission-end faces for the incident illumination light to be emitted from, said incident-end faces being arranged adjacent to each other, and said emission-end faces being arranged away from each other in a lateral direction thereof; and
an incident light controller which adjusts a quantity and quantity ratio of said illumination light emitted from said light source and incident on said respective incident-end faces, said incident light controller provided between said light source and said incident-end faces.

2. The stereoscopic illumination endoscope system according to claim 1, wherein said light guide comprises a pair of said optical fiber bundles; and
wherein said incident-end faces of said pair of optical fiber bundles are formed as substantially semicircular shapes so as to form a substantially circular shape as a whole.

3. The stereoscopic illumination endoscope system according to claim 2, wherein said substantially semicircular incident-end faces are arranged in a vertical direction when said electronic scope is detachably attached to said endoscope processor.

4. The stereoscopic illumination endoscope system according to claim 2, wherein an image pickup device is provided between said emission-end faces of said pair of optical fiber bundles at the distal end of said body insertion part of said electronic scope.

5. The stereoscopic illumination endoscope system according to claim 4, wherein said incident light controller comprises a light quantity control plate which is supported so as to be movable in said vertical direction, said control plate being formed so as to have a light transmittance which varies one of gradually and stepwise along said vertical direction.

6. The stereoscopic illumination endoscope system according to claim 5, wherein said illumination light emitted from said light source comprises a parallel light bundle; and
wherein said light quantity control plate has a lower transmittance in an area where an upper part of said illumination light passes.

7. The stereoscopic illumination endoscope system according to claim 2, wherein said incident light controller comprises a shield plate provided in an optical path between said light source and said incident-end faces of said pair of optical fiber bundles, said shield plate having upper and lower apertures, wherein said shield plate is moved up and down to adjust respective light quantities of said illumination light which pass through said upper and lower apertures of said shield plate.

8. The stereoscopic illumination endoscope system according to claim 2, wherein said incident light controller comprises a shield plate provided in an optical path between said light source and said incident-end faces of said pair of optical fiber bundles,
wherein said shield plate divides said illumination light into a plurality of light bundles to be incident on said incident-end faces, respectively, and said shield plate is moved up and down to adjust respective light quantity of said light bundles.

9. The stereoscopic illumination endoscope system according to claim 1, wherein said light guide comprises a pair of said optical fiber bundles; and
wherein said incident-end faces of said pair of optical fiber bundles are formed as split halves of a polygon so as to form said polygon as a whole when arranged in close contact with each other.

10. The stereoscopic illumination endoscope system according to claim 9, wherein said split halves of said polygon incident-end faces are arranged in a vertical direction when said electronic scope is detachably attached to said endoscope processor.

11. The stereoscopic illumination endoscope system according to claim 9, wherein an image pickup device is provided between said emission-end faces of said pair of optical fiber bundles at the distal end of said body insertion part of said electronic scope.

12. The stereoscopic illumination endoscope system according to claim 9, wherein said incident light controller comprises a light quantity control plate which is supported so as to be movable in said vertical direction, said control plate being formed so as to have a light transmittance which varies one of gradually and stepwise along said vertical direction.

13. The stereoscopic illumination endoscope system according to claim 12, wherein said illumination light emitted from said light source comprises a parallel light bundle; and
wherein said light quantity control plate has a lower transmittance in an area where an upper part of said illumination light passes.

14. The stereoscopic illumination endoscope system according to claim 9, wherein said incident light controller comprises a shield plate provided in an optical path between said light source and said incident-end faces of said pair of optical fiber bundles, said shield plate having upper and lower apertures.

15. The stereoscopic illumination endoscope system according to claim 9, wherein said light shield comprises a shield plate provided in an optical path between said light source and said incident-end faces of said pair of optical fiber bundles, said shield plate being moved up and down to adjust respective light quantities of said illumination light which pass through said upper and lower apertures of said shield plate.

16. The stereoscopic illumination endoscope system according to claim 5, wherein said light source comprises a lamp for emitting a parallel light bundle, and a condenser lens for focusing said parallel light bundle emitted from said lamp; and
wherein said light quantity control plate is provided between said lamp and said condenser lens.

17. The stereoscopic illumination endoscope system according to claim 7, wherein said light source comprises a lamp for emitting a parallel light bundle, and a condenser lens for focusing said parallel light bundle emitted from said lamp;
wherein said shield plate is provided between said condenser lens and said incident-end faces of said optical fiber bundles.

18. An electronic scope detachably attached to the endoscope processor comprising:
a light guide provided therein, wherein illumination light emitted from a light source is projected onto an object to be observed from a distal end of said electronic scope via said light guide, and
wherein said light guide includes a plurality of optical fiber bundles having respective incident-end faces for the illumination light to be incident on and respective emission-end faces for the incident illumination light to be emitted from, said incident-end faces being arranged adjacent to each other, and said emission-end faces being arranged away from each other.

19. An endoscope processor detachably attached to an electronic scope comprising:
a light source which emits illumination light so as to be incident on an incident end face of a light guide provided in said electronic scope and to emit from a distal end of said light guide;
wherein said light guide includes a plurality of optical fiber bundles having respective incident-end faces for said illumination light to be incident on and respective emission-end faces for said incident illumination light to be emitted from, said incident-end faces being arranged adjacent to each other, and said emission-end faces being arranged away from each other in a lateral direction thereof; and
wherein an incident light controller is provided between said light source and said incident-end faces, wherein said incident light controller adjusts a quantity and quantity ratio of said illumination light emitted from said light source and incident on said respective incident-end faces.
